(19) United States
(12) Patent Application Publication
(10) Pub. No.: US 2014/0351828 A1
(43) Pub. Date: Nov. 27, 2014

(54) APPARATUS AND METHOD FOR CONTROLLING MULTI-CORE SYSTEM ON CHIP

(71) Applicant: Electronics and Telecommunications Research Institute, Daejeon (KR)

(72) Inventors: Yoo-Kyoung LEE, Daejeon (KR); Kyung-Jin BYUN, Daejeon (KR); Nak-Woong EUM, Daejeon (KR)

(73) Assignee: Electronics and Telecommunications Research Institute, Daejeon (KR)

(21) Appl. No.: 14/258,806

(22) Filed: Apr. 22, 2014

(30) Foreign Application Priority Data
May 27, 2013 (KR) 10-2013-0059950

(51) Int. Cl. G06F 9/48

(52) U.S. Cl. CPC G06F 9/4881
USPC 718/108

(57) ABSTRACT

An apparatus and method for controlling a multi-core SoC including a main core and at least one sub-core are disclosed. The apparatus includes a determination unit, a storage unit, and a control unit. The determination unit determines whether or not to drive the sub-core by taking the performance or power of the multi-core SoC into consideration. The storage unit stores state information including a register of the main core or the sub-core in accordance with a determination of the determination unit. The control unit performs control so that the main core and the sub-core execute a sub-task, that is, a task of the sub-core, through exchange by sharing the state information.

### CROSS REFERENCE TO RELATED APPLICATION

This application claims the benefit of Korean Patent Application No. 10-2013-0059950, filed on May 27, 2013, which is hereby incorporated by reference in its entirety into this application.

### BACKGROUND OF THE INVENTION

1. Technical Field

The present invention relates generally to an apparatus and method for controlling a multi-core System on Chip (SoC) and, more particularly, to an apparatus and method for controlling a multi-core SoC that are capable of reducing power consumption and performing control so that a main core and a sub-core can perform efficient context switching.

2. Description of the Related Art

With the development of embedded processor technology, the processing speed of a processor becomes fast with a CPU clock speed ranging from several hundreds of mega hertz to 1 Giga hertz or more, and low-power operation becomes important in terms of the nature of an embedded processor. In order to operate a processor with low power, a low-power design for circuits is important. Although an important point of low-power design is the optimization of circuits for a low-power operation in terms of logic, the operating voltage and the operating frequency are important issues in low-power design from an overall point of view.

It may be preferred that the operating voltage be lowered because consumption power increases in proportion to the square of the operating voltage. If the operating voltage is lowered, however, a circuit becomes vulnerable to noise and the consumption power is closely related to operating voltage of a logic gate, so that SoC fabrication process technology is chiefly used.

Although the operating frequency can be controlled depending on the design and the operating environment of a SoC, the operating frequency is in inverse proportion to performance and in proportion to power consumption. Accordingly, in order to fabricate a desired SoC, a compromise suitable for requirements needs to be reached.

In a SoC formed of processor cores, the trend of technology that implements the SoC with low power while maintaining high performance focuses on a method of implementing a SoC formed of a multi-core including a plurality of cores in order to lower an operating frequency for low power and to realize high performance at a low frequency. In this configuration scheme, a method of further lowering power includes a method of driving multiple cores by blocking power to be supplied to unnecessary cores of the multiple cores or by lowering an operating frequency. In this method, however, a complicated operation is generally required because software needs to be supported and hardware functions need to be implemented and the entire system is influenced.

A method capable of effectively driving a SoC formed of multiple cores includes a method of assigning threads to the multiple cores by running Linux in Symmetric Multi-Processor (SMP) mode using a Linux kernel, thereby increasing performance.

Furthermore, Korean Patent Application Publication No. 2010-0032161 introduces a technology in which a main processor switches the power management state of a multi-processor depending on a system state. However, a technology capable of interrupting some cores for low power or controlling low power has not yet been put to practical use.

Accordingly, in order to implement a low-power operation in a multi-core SoC including a main core and another core (i.e., a sub-core), there is a need for a technology of interrupting the driving of the sub-core and enabling the main core to take over a task being performed by the sub-core, thereby preventing a problem from occurring in the execution of a program.

### SUMMARY OF THE INVENTION

Accordingly, the present invention has been made keeping in mind the above problems occurring in the conventional art, and an object of the present invention is to, in a multi-core SoC, enable a main core to interrupt a sub-core and also enable a task being performed by the sub-core to be handed over to the main core.

Another object of the present invention is to, in a multi-core SoC, enable a main core to interrupt a sub-core, thereby reducing consumption power, and also enable the continuity of a task being performed by the sub-core to be maintained.

Yet another object of the present invention is to enable an interrupted core to be resumed when high performance is required, thereby enabling efficient low-power control capable of implementing the context switching of a process between cores.

In accordance with an aspect of the present invention, there is provided an apparatus for controlling a multi-core SoC including a main core and at least one sub-core, the apparatus including a determination unit configured to determine whether or not to drive the sub-core by taking performance or power of the multi-core SoC into consideration; a storage unit configured to store state information including a register of the main core or the sub-core in accordance with a determination of the determination unit; and a control unit configured to perform control so that the main core and the sub-core execute a sub-task, that is, a task of the sub-core, through exchange by sharing the state information.

The determination unit may make an interruption determination of interrupting the driving of the sub-core or a resumption determination of resuming the driving of the sub-core.

The storage unit may store information about the current state of the sub-core if the determination unit makes the interruption determination.

The control unit may perform control so that an interruption instruction is transferred to the sub-core and thus the sub-core interrupts the execution of the sub-task.

The control unit may issue an exchange instruction to the main core so that the main core continues to execute the sub-task based on the information about the current state of the sub-core stored in the storage unit.

The main core may perform a main task, that is, its own original task, and the sub-task through context switching.

The context switching may be performed in a predetermined cycle based on a user's definition.

The storage unit may store information about the current state of the main core if the determination unit makes the resumption determination.

The control unit may perform control so that an exchange interruption instruction is transferred to the main core and thus the main core interrupts the execution of the sub-task.

The control unit may perform control so that a wake-up instruction is transferred to the sub-core and thus the sub-core continues to execute the sub-task based on the information about the current state of the main core stored in the storage unit.

In accordance with an aspect of the present invention, there is provided a method of controlling a multi-core SoC including a main core and at least one sub-core, the method including determining whether or not to drive the sub-core by taking the performance or power of the multi-core SoC into consideration; storing state information including a register of the main core or the sub-core in accordance with a determination of the determination unit; and performing control so that the main core and the sub-core execute a sub-task, that is, a task of the sub-core, through exchange by sharing the state information.

Determining whether or not to drive the sub-core may include making an interruption determination of interrupting the driving of the sub-core or a resumption determination of resuming the driving of the sub-core.

Storing the state information may include storing information about the current state of the sub-core if the interruption determination is made.

Performing control may include performing control so that an interruption instruction is transferred to the sub-core and thus the sub-core interrupts the execution of the sub-task.

Performing control may include issuing an exchange instruction to the main core so that the main core continues to execute the sub-task based on the information about the current state of the sub-core stored in the state information.

The main core may execute a main task, that is, its own original task, and the sub-task through context switching.

The context switching may be performed in a predetermined cycle based on a user's definition.

Storing the state information may include storing information about the current state of the main core if the resumption determination is made.

Performing control may include performing control so that an exchange interruption instruction is transferred to the main core and thus the main core interrupts the execution of the sub-task.

Performing control may include performing control so that a wake-up instruction is transferred to the sub-core and thus the sub-core continues to perform the sub-task based on the stored information about the current state of the main core.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of an apparatus for controlling a multi-core SoC according to the present invention;

FIG. 2 is a diagram illustrating an embodiment of the apparatus for controlling a multi-core SoC according to the present invention;

FIG. 3 a diagram illustrating another embodiment of the apparatus for controlling a multi-core SoC according to the present invention;

FIG. 4 is a flowchart illustrating a method for controlling a multi-core SoC according to the present invention; and

FIG. 5 is a diagram illustrating an embodiment of the method for controlling a multi-core SoC according to the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

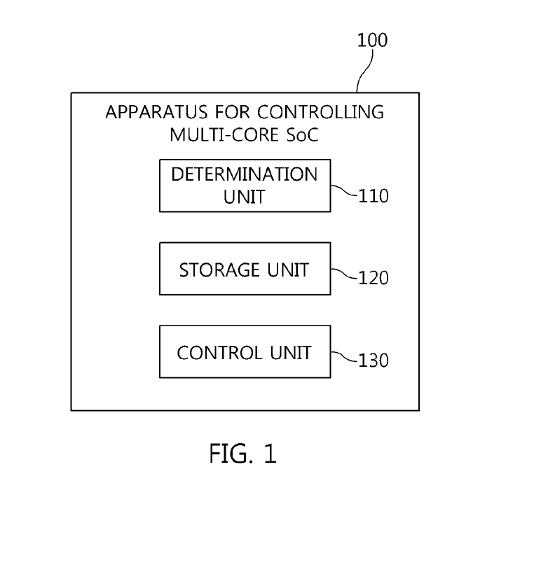

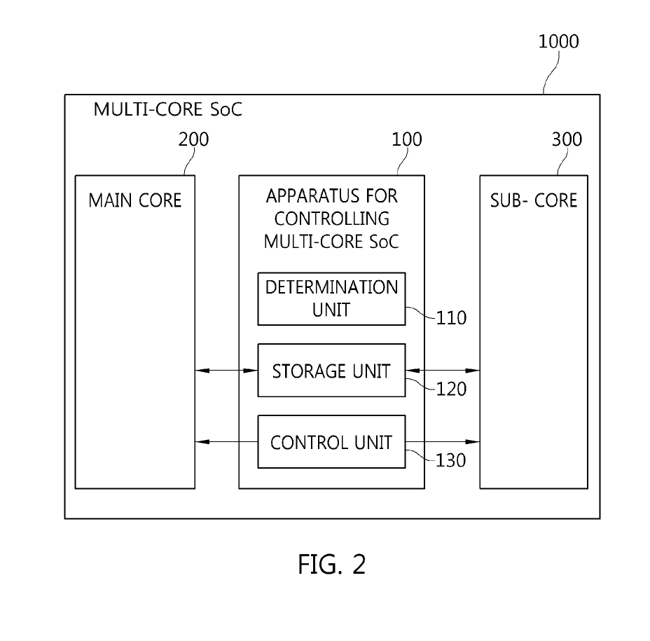

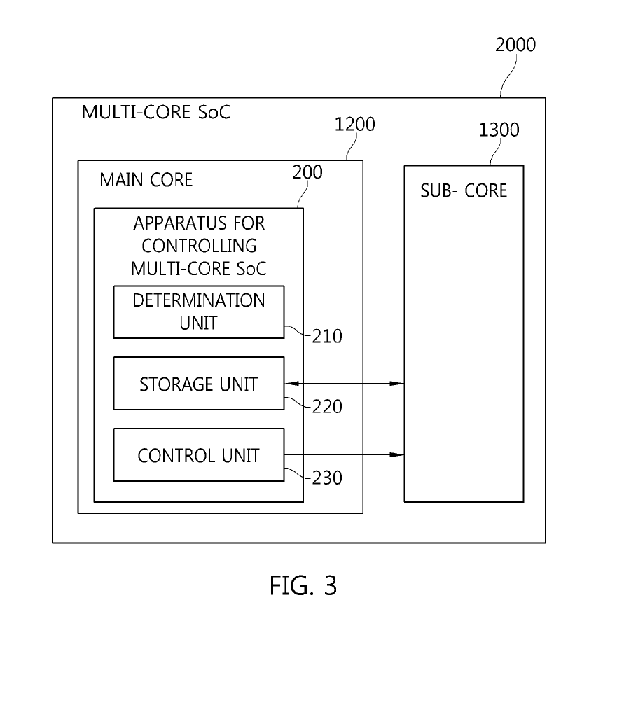

The constructions and operations of an apparatus for controlling a multi-core SoC according to the present invention will be described below. FIG. 1 is a block diagram of an apparatus for controlling a multi-core SoC according to the present invention. FIG. 2 is a diagram illustrating an embodiment of the apparatus for controlling a multi-core SoC according to the present invention. FIG. 3 a diagram illustrating another embodiment of the apparatus for controlling a multi-core SoC according to the present invention.

Referring to FIG. 1, an apparatus 100 for controlling a multi-core SoC including one main core and at least one sub-core includes a determination unit 110 configured to determine whether or not to operate the sub-core by taking the performance or power of the multi-core SoC into consideration, a storage unit 120 configured to store state information including the register of the main core or the sub-core in accordance with a determination of the determination unit 110, and a control unit 130 configured to perform control so that the main core and the sub-core can share the state information, thereby enabling the main core and the sub-core to execute a sub-task, that is, the task of the sub-core, while exchanging the sub-task.

An embodiment of the apparatus for controlling a multi-core SoC according to the present invention will be described below with reference to FIG. 2. The multi-core SoC 1000 includes a main core 200, a sub-core 300, and the apparatus 100 for controlling a multi-core SoC. The main core 200 and the sub-core 300 have the same function.

The determination unit 110 may make an interruption determination of interrupting the driving of the sub-core or a resumption determination of resuming the driving of the sub-core. More specifically, in the multi-core SoC, each of the main core 200 and the sub-core 300 executes its own task.

The task of the main core 200 performed by the main core 200 is referred to as a main task, and the task of the sub-core 300 performed by the sub-core 300 is referred to as a sub-task.

The determination unit 110 determines whether or not to drive the sub-core 300 by taking the performance or power of the multi-core SoC into consideration. For example, if high performance is required, the sub-core 300 will be driven.

For another example, if the determination unit 110 determines that the main core 200 can perform even the sub-task, that is, the task of the sub-core 300, while performing the main task, that is, its own task, the sub-core 300 does not need to be driven.

In the former case, the determination unit 110 may make the resumption determination of determining the driving of the driving of the sub-core 300. In the latter case, the determination unit 110 may make the interruption determination of interrupting the driving of the sub-core 300.

The storage unit 120 performs a function of storing information about the states of the main core 200 and the sub-core 300. More specifically, the storage unit 120 stores information about the current state of the sub-core 300 if the determination unit 110 makes the interruption determination, and stores information about the current state of the main core 200 if the determination unit 110 makes the resumption determination. In this case, the information about the state means information including information about the register of the main core or the sub-core, and may include the value of a Program Counter (PC) and information about a Processor State Register (PSR).

The main core 200 and the sub-core 300 may share the register based on the state information stored in the storage unit 120. The main core 200 and the sub-core 300 may use a shared register bus when sharing the state information stored in the storage unit 120.

For example, when the main core 200 executes the sub-task, it may use information about the state of the sub-core 300 that is stored in the storage unit 120.

The control unit 130 functions to perform control so that an instruction is performed on the sub-core and thus the sub-core interrupts or resumes the execution of the sub-task.

More specifically, if the determination unit 110 makes the interruption determination, the control unit 130 issues an interruption instruction to the sub-core so that the sub-core interrupts the execution of the sub-task.

The control unit 130 issues an exchange instruction so that the main core takes over and executes the sub-task based on the information about the state of the sub-core. The main core executing the sub-task, that is, the task of the sub-core 300, as described above, is referred to as exchange execution. Accordingly, although the sub-core 300 interrupts the execution of the sub-task, the main core 200 may continue to execute the sub-task (i.e., exchange execution) using the register of the sub-core 300 stored in the information about the state.

In this case, the main core 200 executes the main task, that is, its own original task, and the sub-task through context switching. The context switching is performed in a predetermined cycle based on the definition of a user, and may be set such that it is performed in a cycle of 1 ms.

If the determination unit 110 makes the resumption determination, the control unit 130 issues an exchange interruption instruction to the sub-core 300 and the main core 200 so that the main core 200 interrupts the execution of the sub-task (i.e., exchange execution).

In this case, the control unit 130 performs control so that a wake-up instruction is issued to the sub-core 300 and thus the sub-core continues to execute the sub-task based on the information about the state of the main core 200.

Accordingly, although the main core 200 interrupts the exchange execution of the sub-task, the sub-core 300 may continue to execute the sub-task using the register of the main core 200 that is stored in the state information.

In this case, the main core 200 terminates the execution of the main task, that is, its own original task, and the sub-task through context switching, and performs only the main task, that is, its own original task.

Another embodiment of the apparatus for controlling a multi-core SoC according to the present invention will be described below with reference to FIG. 3.

The multi-core SoC 2000 includes a main core 1200 and a sub-core 1300. The main core 1200 includes an apparatus 200 for controlling a multi-core SoC according to the present invention. The main core 1200 and the sub-core 1300 have the same function.

A determination unit 210 may make an interruption determination of interrupting the driving of the sub-core 1300 or a resumption determination of resuming the driving of the sub-core 1300. More specifically, each of the main core 1200 and the sub-core 1300 of the multi-core SoC 2000 executes its own task.

The task of the main core 1200 performed by the main core 1200 is referred to as a main task, and the task of the sub-core 1300 performed by the sub-core 1300 is referred to as a sub-task.

The determination unit 210 determines whether or not to drive the sub-core 1300 by taking the performance or power of the multi-core SoC 2000 into consideration. For example, if high performance is required, the sub-core 1300 will be driven.

If the determination unit 210 determines that the main core 1200 can perform even the sub-task, that is, the task of the sub-core 1300, while performing the main task, that is, its own task, the sub-core 1300 does not need to be driven.

In the former case, the determination unit 210 may make the resumption determination of driving the sub-core 1300. In the latter case, the determination unit 210 may make the interruption determination of interrupting the driving of the sub-core 1300.

A storage unit 220 functions to store information about the states of the main core 1200 and the sub-core 1300. More specifically, the storage unit 220 stores information about the current state of the sub-core 1300 if the determination unit 210 makes the interruption determination, and stores information about the current state of the main core 1200 if the determination unit 210 makes the resumption determination. In this case, the information about the state means information including information about the register of the main core or the sub-core, and may include the value of a PC and information about a PSR.

The main core 1200 and the sub-core 1300 may share the register based on the state information stored in the storage unit 220. The main core 1200 and the sub-core 1300 may use a shared register bus when they share the state information stored in the storage unit 220.

For example, the main core 1200 may use information about the state of the sub-core 1300 stored in the storage unit 220 when performing the sub-task.

A control unit 230 functions to perform control so that an instruction is performed on the sub-core and thus the sub-core interrupts or resumes the execution of the sub-task.

More specifically, if the determination unit 210 makes the interruption determination, the control unit 230 performs control so that an interruption instruction is performed on the sub-core 1300 and thus the sub-core interrupts the execution of the sub-task.

In this case, the control unit 230 issues an exchange instruction so that the main core 1200 takes over and executes the sub-task based on information about the state of the sub-core 1300. The main core 1200 executing the sub-task, that is, the task of the sub-core 1300, as described above, is referred to as exchange execution. Accordingly, although the sub-core 1300 interrupts the execution of the sub-task, the main core 200 may continue to execute the sub-task (i.e., exchange execution) using the register of the sub-core 1300 stored in the state information.

In this case, the main core 1200 performs the main task, that is, its own original task, and the sub-task through context switching. The context switching is performed in a predetermined cycle based on the definition of a user, and may be set such that it is performed in a cycle of 1 ms.

If the determination unit 210 makes the resumption determination, the control unit 230 issues an exchange interruption instruction to the sub-core 1300 and the main core 1200 so that the main core 1200 interrupts the execution of the sub-task (exchange execution).

In this case, the control unit 230 performs control so that a wake-up instruction is issued to the sub-core 1300 and thus the sub-core continues to execute the sub-task based on the information about the state of the main core 1200.

Accordingly, although the main core 1200 interrupts the exchange execution of the sub-task, the sub-core 1300 may continue to execute the sub-task using the register of the main core 1200 stored in the state information.

In this case, the main core 1200 terminates the execution of the main task, that is, its own original task, and the sub-task through context switching, and performs only the main task, that is, its own original task.

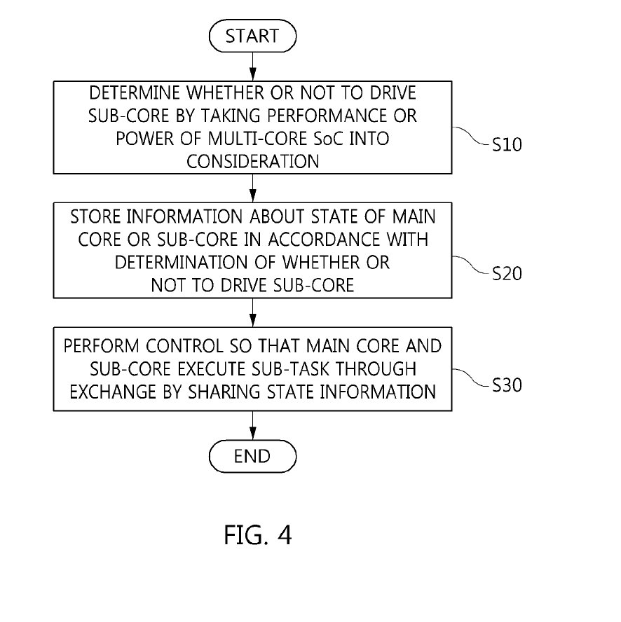

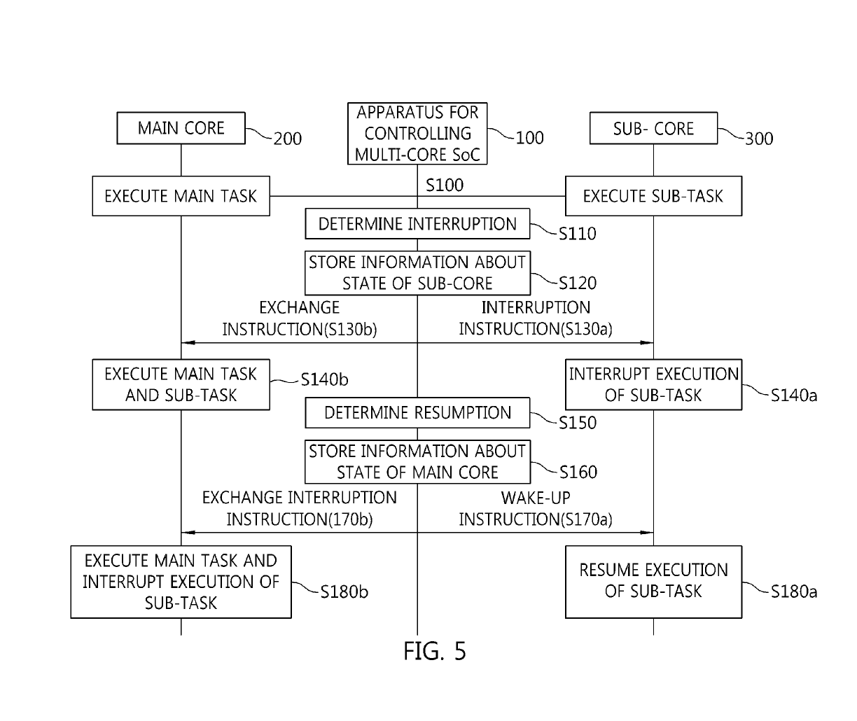

Methods for controlling the multi-core SoC according to the present invention will be described below. FIG. 4 is a flowchart illustrating a method for controlling the multi-core SoC according to the present invention. FIG. 5 is a diagram illustrating an embodiment of the method for controlling the multi-core SoC according to the present invention.

Referring to FIG. 4, the method for controlling the multi-core SoC including one main core and at least one sub-core includes determining whether or not to drive the sub-core by taking the performance or power of the multi-core SoC into consideration at step S10, storing state information including the register of the main core or the sub-core in accordance with the determination of the determination unit at step S20, and performing control so that the main core and the sub-core execute a sub-task, that is, the task of the sub-core, through exchange by sharing the state information at step S30.

At step S10, an interruption determination of interrupting the driving of the sub-core or a resumption determination of resuming the driving of the sub-core may be made. More specifically, each of the main core and the sub-core of the multi-core SoC executes its own task.

In this case, the task of the main core performed by the main core is referred to as a main task, and the task of the sub-core performed by the sub-core is referred to as a sub-task.

At step S10, whether or not to drive the sub-core is determined by taking the performance or power of the multi-core SoC into consideration. For example, if high performance is required, the sub-core will be driven.

For another example, if it is determined that the main core may perform even the sub-task, that is, the task of the sub-core, while performing the main task, that is, its own task, the sub-core does not need to be driven.

Accordingly, at step S10, the resumption determination of determining the driving of the driving of the sub-core may be made in the former case, and the interruption determination of interrupting the driving of the sub-core may be made in the latter case.

At step S20, information about the state of the main core and the sub-core is stored. More specifically, if the interruption determination is made at step S10, information about the current state of the sub-core is stored. If the resumption determination is made at step S10, information about the current state of the main core is stored. In this case, the state information means information including information about the register of the main core or the sub-core and may include the value of a PC and information about a PSR.

The main core and the sub-core may share the register based on the state information stored in the storage unit. The main core and the sub-core may use a shared register bus when sharing the state information stored in the storage unit.

For example, when the main core executes the sub-task, it may use information about the state of the sub-core.

At step S30, an instruction is performed on the sub-core so that the sub-core interrupts or resumes the execution of the sub-task.

More specifically, if the interruption determination is made at step S10, the interruption instruction is performed on the sub-core so that the sub-core interrupts the execution of the sub-task at step S30.

In this case, an exchange instruction is issued so that the main core takes over and executes the sub-task based on information about the state of the sub-core at step S30. The main core executing the sub-task, that is, the task of the sub-core, as described above, is referred to as exchange execution. Accordingly, although the sub-core interrupts the execution of the sub-task, the main core may continue to execute the sub-task (i.e., exchange execution) using the register of the sub-core that is stored in the information about the state.

In this case, the main core performs the main task, that is, its own original task, and the sub-task through context switching. The context switching is performed in a predetermined cycle based on the definition of a user, and may be set such that it is performed in a cycle of 1 ms.

Furthermore, if the resumption determination is made at step S10, the control unit issues an exchange interruption instruction to the main core so that the main core interrupts the execution of the sub-task (i.e., exchange execution) at step S30.

In this case, a wake-up instruction is performed on the sub-core so that the sub-core continues to execute the sub-task based on information about the state of the main core at step S30.

Accordingly, although the main core interrupts the exchange execution of the sub-task, the sub-core may continue to execute the sub-task using the register of the main core that is stored in the state information.

In this case, the main core terminates the execution of the main task, that is, its own original task, and the sub-task through context switching, and performs only the main task, that is, its own original task.

An embodiment of the method for controlling a multi-core SoC according to the present invention will be described below with reference to FIG. 5.

The main core 200 performs a main task, and the sub-core 300 performs a sub-task at step S100. In this case, the apparatus 100 for controlling a multi-core SoC determines whether or not to drive the sub-core. If an interruption determination is made at step S110, information about the state of the sub-core 300 at a current point of time is stored at step S120. The state information includes information about the state of the sub-core 300 and, in particular, includes information about a register.

Furthermore, the apparatus 100 for controlling a multi-core SoC issues an interruption instruction to the sub-core 300 at step S130a, and issues an exchange instruction on the main core 200 at step S130b.

In response to the interruption instruction, the sub-core 300 interrupts the execution of the sub-task at step S140a. In response to the exchange instruction, the main core 200 also executes the sub-task while continuing to perform the original main task at step S140b. That is, although the sub-core 300 interrupts the execution of the sub-task, the main core 200 may continue to execute the sub-task (i.e., exchange execution) using the register of the sub-core 300 stored in the state information.

In this case, the main core 200 terminates the execution of the main task, that is, its own original task, and the sub-task through context switching, and performs only the main task, that is, its own original task

The main core 200 performs the main task, that is, its own original task, and the sub-task through context switching. The context switching is performed in a predetermined cycle based on the definition of a user, and may be set such that it is performed in a cycle of 1 ms.

Thereafter, if a resumption determination is made at step S150, the apparatus 100 for controlling a multi-core SoC stores information about the state of the main core 200 at a current point of time at step S160. The state information includes information about the state of the main core 200, and, in particular, includes information about a register.

Furthermore, the apparatus 100 for controlling a multi-core SoC issues an exchange interruption instruction to the main core 200 at step S170b, and issues a wake-up instruction to the sub-core 300 at step S170a. In response to the exchange interruption instruction, the main core 200 interrupts the execution of the sub-task (i.e., exchange execution) and performs only the main task at step S180b. In response to the wake-up instruction, the sub-core 300 resumes the execution of the sub-task at step 180a. Although the main core 200 interrupts the exchange execution of the sub-task, the sub-core 300 may continue to execute the sub-task using the register of the main core 200 stored in the state information.

As described above, according to the present invention, in the multi-core SoC, the main core thereof may interrupt the driving of the sub-core and take over a task that is being performed by the sub-core.

Furthermore, according to the present invention, in the multi-core SoC, the main core may interrupt the driving of the sub-core, thereby reducing consumption power, and also maintain the continuity of a task being performed by the sub-core.

Furthermore, according to the present invention, when high performance is required, the driving of an interrupted core is resumed, thereby achieving efficient low-power control capable of implementing the context switching of a process between cores.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for controlling a multi-core System on Chip (SoC) including a main core and at least one sub-core, the apparatus comprising:
a determination unit configured to determine whether or not to drive the sub-core by taking performance or power of the multi-core SoC into consideration;
a storage unit configured to store state information including a register of the main core or the sub-core in accordance with a determination of the determination unit; and
a control unit configured to perform control so that the main core and the sub-core execute a sub-task, that is, a task of the sub-core, through exchange by sharing the state information.

2. The apparatus of claim 1, wherein the determination unit makes an interruption determination of interrupting the driving of the sub-core or a resumption determination of resuming the driving of the sub-core.

3. The apparatus of claim 2, wherein the storage unit stores information about a current state of the sub-core if the determination unit makes the interruption determination.

4. The apparatus of claim 3, wherein the control unit performs control so that an interruption instruction is transferred to the sub-core and thus the sub-core interrupts the execution of the sub-task.

5. The apparatus of claim 4, wherein the control unit issues an exchange instruction to the main core so that the main core continues to execute the sub-task based on the information about the current state of the sub-core stored in the storage unit.

6. The apparatus of claim 5, wherein the main core performs a main task, that is, its own original task, and the sub-task through context switching.

7. The apparatus of claim 6, wherein the context switching is performed in a predetermined cycle based on a user's definition.

8. The apparatus of claim 2, wherein the storage unit stores information about a current state of the main core if the determination unit makes the resumption determination.

9. The apparatus of claim 8, wherein the control unit performs control so that an exchange interruption instruction is transferred to the main core and thus the main core interrupts the execution of the sub-task.

10. The apparatus of claim 9, wherein the control unit performs control so that a wake-up instruction is transferred to the sub-core and thus the sub-core continues to execute the sub-task based on the information about the current state of the main core stored in the storage unit.

11. A method of controlling a multi-core SoC including a main core and at least one sub-core, the method comprising:
determining whether or not to drive the sub-core by taking performance or power of the multi-core SoC into consideration;
storing state information including a register of the main core or the sub-core in accordance with a determination of the determination unit; and
performing control so that the main core and the sub-core execute a sub-task, that is, a task of the sub-core, through exchange by sharing the state information.

12. The method of claim 11, wherein determining whether or not to drive the sub-core comprises making an interruption determination of interrupting the driving of the sub-core or a resumption determination of resuming the driving of the sub-core.

13. The method of claim 12, wherein storing the state information comprises storing information about a current state of the sub-core if the interruption determination is made.

14. The method of claim 13, wherein performing control comprises performing control so that an interruption instruction is transferred to the sub-core and thus the sub-core interrupts the execution of the sub-task.

15. The method of claim 14, wherein performing control comprises issuing an exchange instruction to the main core so that the main core continues to execute the sub-task based on the information about the current state of the sub-core stored in the state information.

16. The method of claim 15, wherein the main core executes a main task, that is, its own original task, and the sub-task through context switching.

17. The method of claim 16, wherein the context switching is performed in a predetermined cycle based on a user's definition.

18. The method of claim 12, wherein storing the state information comprises storing information about a current state of the main core if the resumption determination is made.

19. The method of claim 18, wherein performing control comprises performing control so that an exchange interruption instruction is transferred to the main core and thus the main core interrupts the execution of the sub-task.

20. The method of claim 19, wherein performing control comprises performing control so that a wake-up instruction is transferred to the sub-core and thus the sub-core continues to perform the sub-task based on the stored information about the current state of the main core.
